(19) United States
(12) Patent Application Publication
(10) Pub. No.: US 2004/0234797 A1
(43) Pub. Date: Nov. 25, 2004

(54) Oxygen scavenging film with antifog properties

(75) Inventors: Dwight W. Schwark, Simpsonville, SC (US); Drew Speer, Simpsonville, SC (US)

Correspondence Address: Mark B. Quatt, Sealed Air Corporation, P.O. Box 464, Duncan, SC, 29334, US

(73) Assignee: Cryovac, Inc.

(21) Appl. No.: 10/444,624

(22) Filed: May 23, 2003

(51) Int. Cl. B32B 27/08; B32B 27/34; B32B 27/32; B32B 27/30; B32B 27/00

(52) U.S. Cl. 428/474.4; 428/475.5; 428/476.1; 428/476.3; 428/500; 428/515

(57) ABSTRACT

A multilayer film includes a first and second outer layer each including a polymer; and an internal layer including an oxygen scavenger; where one of the first and second outer layers includes a blend of a polymer and an antifog agent, where the antifog agent includes one or more of glycerol fatty acid ester, polyglycerol fatty acid ester, polyethylene glycol fatty acid ester, polyethylene glycol alkyl ether, ethoxylated alkyl phenol, sorbitan ester, ethoxylated sorbitan ester, and alkanol; and wherein the first outer layer includes more than 3% and less than 8%, by weight of the first outer layer, of antifog agent. Unexpected improvements in oxygen scavenging and/or antifog properties of the film are obtained by the combination of the oxygen scavenger and antifog agent.

### FIELD OF THE INVENTION

The invention relates to an oxygen scavenging film with antifog properties.

### BACKGROUND OF THE INVENTION

It is known that many oxygen sensitive products, including food products such as meat and cheese, smoked and processed luncheon meats, as well as non-food products such as electronic components, pharmaceuticals, and medical products, deteriorate in the presence of oxygen. Both the color and the flavor of foods can be adversely affected. The oxidation of lipids within the food product can result in the development of rancidity. These products benefit from the use of oxygen scavengers in their packaging.

Some of these oxygen scavengers, typically unsaturated polymers with a transition metal catalyst, can be triggered or activated by actinic radiation. Such materials offer the advantage of an oxygen scavenger that does not prematurely scavenge oxygen until such time as the user decides to use the oxygen scavenger in a commercial packaging environment. The oxygen scavenger is thus “dormant” until it is passed through a triggering unit, typically a bank of UV lights through which an oxygen scavenger in the form of a film is passed to trigger the oxygen scavenging activity of the material. This is usually done just prior to a packaging step, in which a package having as a component the oxygen scavenger is made, with an oxygen sensitive product placed in the package prior to closure of the package to extend the shelf life of the oxygen sensitive product.

Also, packaging films often require antifog properties in order to provide a final packaged product without excessive moisture buildup on the interior surface of the package. Packaging films typically require antifog properties for packaging certain types of food products. End use applications include refrigerated MAP lidding applications such as trays, semi-rigid containers and case-ready packaging.

It has been found that an antifog agent may be incorporated into the sealant layer on one side of an oxygen scavenging film, adjacent to the oxygen scavenging layer, to yield antifog performance often superior to that of conventional, non oxygen scavenging antifog films, while often actually enhancing oxygen scavenging performance. In addition, heat seal and lamination of the oxygen scavenging antifog film are not significantly impacted by the presence of the antifog agent. This result is surprising given that similar incorporation of amide wax slip agents in oxygen scavenging films at levels approximately ten times less than antifog agent levels are seen to significantly degrade oxygen scavenging, lamination, and heat seal performance.

Surprisingly, antifog agent in a single sealant layer adjacent to the oxygen scavenging layer is able to bloom to the surface and provide superior antifog properties compared to a conventional, symmetric antifog film which has two sealant layers each containing the same antifog agent present in the sealant layer of the oxygen scavenging antifog film. Also surprising is the fact that no significant migratory additive-induced degradation of oxygen scavenging performance is observed with oxygen scavenging antifog films of the present invention. In contrast, ten times lower concentrations of other migratory film additives, such as erucamide, have been found to significantly and undesirably decrease oxygen scavenging rate. Higher levels of antifog agent were observed to yield better oxygen scavenging performance. In addition, it was found that migration of an antifog agent did not significantly adversely impact heat sealing or lamination of the antifog containing oxygen scavenging films of the invention.

Typical antifog films employ a symmetric film structure with antifog agent present in both outer surface layers of the film. The symmetric film structure is employed both because of simplicity in extrusion of the film and also because two opposing layers of antifog agent minimize loss of the antifog agent from the surface layer into the core of the film. While such a symmetric, dual antifog layer film has advantages, there are also numerous disadvantages. As with slip agents, antifog agents are known to degrade heat seal and lamination bond strength, as well as ink adhesion. These limitations are present for a film that typically requires antifog performance on only one side of the film. Thus, one advantage of the invention lies in the ability to generate an antifog film that has superior antifog properties to the conventional dual antifog layer films, with antifog only on the surface of interest, and without degrading other film properties. In the case of the present invention, the advantages are improved oxygen scavenging performance and the ability to laminate and heat seal the film. While the process of applying a surface coating to one side of the film can yield antifog properties, there are numerous manufacturing and environmental costs associated with this process. Hence, the use of a migratory antifog agent within a single extruded surface layer provides numerous manufacturing and performance benefits.

### DEFINITIONS

“Antifog agent” and the like herein means or refers to an additive that prevents or reduces the condensation of fine droplets of water on a surface of a packaging film. Such additives function as mild wetting agents that exude to the surface of the packaging film, and lower the surface tension of the water, thereby causing the water to spread into a continuous film. Examples of antifog agents are, without limitation, glycerol fatty acid ester, polyglycerol fatty acid ester, polyethylene glycol fatty acid ester, polyethylene glycol alkyl ether, ethoxylated alkyl phenol, sorbitan ester, ethoxylated sorbitan ester, and alkanols.

Glycerol fatty acid ester includes by way of example glycerol mono and dilaurate, glycerol mono and distearate, glycerol mono and dioleate.

Polyglycerol fatty acid ester includes by way of example diglycerol monolaurate and diglycerol monooleate.

Such glycerol and polyglycerol fatty acid esters are usually a complex mixture of several different species of varying glycerol number and ester substitution. In addition, these materials may also contain glycerol and propylene glycol.

Polyethylene glycol fatty acid ester includes by way of example polyethylene glycol monolaurate, polyethylene glycol monostearate, and polyethylene glycol monooleate.

Polyethylene glycol alkyl ether includes by way of example polyethylene glycol lauryl alcohol ether and polyethylene glycol oleyl alcohol ether.

Ethoxylated alkyl phenol includes by way of example ethoxylated nonyl phenol, ethoxylated dodecyl phenol, and ethoxylated tetramethylbutyl phenol.

Sorbitan ester includes by way of example sorbitan monolaurate, sorbitan monopalmitate, sorbitan monostearate, sorbitan tristearate, sorbitan monooleate, and sorbitan trioleate.

Ethoxylated sorbitan ester includes by way of example ethoxylated sorbitan monolaurate, sorbitan monopalmitate, sorbitan monostearate, sorbitan tristearate, sorbitan monooleate, and sorbitan trioleate.

Alkanol includes by way of example stearyl and oleyl alcohol. “Oxygen scavenger”, “oxygen scavenging”, and the like herein means or refers to a composition, compound, film, film layer, coating, plastisol, gasket, or the like which can consume, deplete or react with oxygen from a given environment.

“Internal layer” and the like herein means a layer of a multilayer film that is not an outer layer, i.e. both surfaces of the internal layer are joined to other layers of the film.

“Ethylene/alpha-olefin copolymer” (EAO) herein refers to copolymers of ethylene with one or more comonomers selected from C₃ to C₁₀ alpha-olefins such as propene, butene-1,hexene-1, octene-1, etc. in which the molecules of the copolymers comprise long polymer chains with relatively few side chain branches arising from the alpha-olefin which was reacted with ethylene. This molecular structure is to be contrasted with conventional high pressure low or medium density polyethylenes which are highly branched with respect to EAOs and which high pressure polyethylenes contain both long chain and short chain branches. EAO includes such heterogeneous materials as linear medium density polyethylene (LMDPE), linear low density polyethylene (LLDPE), and very low and ultra low density polyethylene (VLDPE and ULDPE), such as DOWLEX™ or ATTANE™ resins supplied by Dow, and ESCORENE™ or EXCEED™ resins supplied by Exxon; as well as linear homogeneous ethylene/alpha olefin copolymers (HEAO) such as TAFMER™ resins supplied by Mitsui Petrochemical Corporation, EXACT™ resins supplied by Exxon, or long chain branched (HEAO) AFFINITY™ resins supplied by the Dow Chemical Company, or ENGAGE™ resins supplied by DuPont Dow Elastomers.

“Ethylene homopolymer or copolymer” herein refers to ethylene homopolymer such as low density polyethylene; ethylene/alpha olefin copolymer such as those defined herein; ethylene/vinyl acetate copolymer; ethylene/alkyl acrylate copolymer; ethylene/(meth)acrylic acid copolymer; or ionomer resin.

“EVOH” herein refers to the saponified product of ethylene/vinyl ester copolymer, generally of ethylene/vinyl acetate copolymer, wherein the ethylene content is typically between 20 and 60 mole % of the copolymer, and the degree of saponification is generally higher than 85%, preferably higher than 95%.

“High density polyethylene” (HDPE) herein refers to a polyethylene having a density of between 0.94 and 0.965 grams per cubic centimeter.

“lonomer resin” herein refers to a copolymer of ethylene and an ethylenically unsaturated monocarboxylic acid having the carboxylic acid groups partially neutralized by a metal ion, such as sodium or zinc, preferably zinc. Useful ionomers include those:

in which sufficient metal ion is present to neutralize from about 15% to about 60% of the acid groups in the ionomer. The carboxylic acid is preferably “(meth)acrylic acid”—i.e. acrylic acid and/or methacrylic acid;

having at least 50 weight % and preferably at least 80 weight % ethylene units;

having from 1 to 20 weight percent acid units; and

available, for example, from DuPont Corporation (Wilmington, Del.) under the SURLYN trademark.

“Polyamide” herein refers to polymers having amide linkages along the molecular chain, and preferably to synthetic polyamides such as nylons. Furthermore, such term encompasses both polymers comprising repeating units derived from monomers, such as caprolactam, which polymerize to form a polyamide, as well as polymers of diamines and diacids, and copolymers of two or more amide monomers, including nylon terpolymers, sometimes referred to in the art as “copolyamides”. “Polyamide” specifically includes those aliphatic polyamides or copolyamides commonly referred to as e.g. polyamide 6 (homopolymer based on ε-caprolactam), polyamide 6,6 (homopolycondensate based on hexamethylene diamine and adipic acid), polyamide 6,9 (homopolycondensate based on hexamethylene diamine and azelaic acid), polyamide 6,10 (homopolycondensate based on hexamethylene diamine and sebacic acid), polyamide 6,12 (homopolycondensate based on hexamethylene diamine and dodecandioic acid), polyamide 11 (homopolymer based on 11-aminoundecanoic acid), polyamide 12 (homopolymer based on ω-aminododecanoic acid or on laurolactam), polyamide 6/12 (polyamide copolymer based on ε-caprolactam and laurolactam), polyamide 6/6,6 (polyamide copolymer based on ε-caprolactam and hexamethylenediamine and adipic acid), polyamide 6,6/6,10 (polyamide copolymers based on hexamethylenediamine, adipic acid and sebacic acid), modifications thereof and blends thereof. Said term also includes crystalline or partially crystalline, or amorphous, aromatic or partially aromatic, polyamides. Examples of partially crystalline aromatic polyamides include meta-xylylene adipamide (MXD6), copolymers such as MXD6/MXDI, and the like. Examples of amorphous, semi-aromatic polyamides nonexclusively include poly(hexamethylene isophthalamide-co-terephthalamide) (PA-6,I/6T), poly(hexamethylene isophthalamide) (PA-6,I), and other polyamides abbreviated as PA-MXDI, PA-6/MXDT/I, PA-6,6/6I and the like.

“Film” herein means a film, laminate, sheet, web, coating, or the like, which can be used to package an oxygen sensitive product. The film can be used as a component in a rigid, semi-rigid, or flexible product, and can be adhered to a non-polymeric or non-thermoplastic substrate such as paper or metal. The film can also be used as a coupon or insert within a package.

“Polymer” and the like herein means a homopolymer, but also copolymers thereof, including bispolymers, terpolymers, etc.

“Trigger” and the like herein means that process defined in U.S. Pat. No. 5,211,875, whereby oxygen scavenging is initiated (i.e. activated) by subjecting an article such as a film to actinic radiation, such as ionizing radiation, such as gamma radiation, having a wavelength of less than about 750 nm at an intensity of at least about 1.6 mW/cm² or an electron beam at a dose of at least 0.2 megarads (MR), wherein after initiation the oxygen scavenging rate of the article is at least about 0.05 cc oxygen per day per gram of oxidizable organic compound for at least two days after oxygen scavenging is initiated. Preferred is a method offering a short “induction period” (the time that elapses, after exposing the oxygen scavenging component to a source of actinic radiation, before initiation of the oxygen scavenging activity begins) so that the oxygen scavenging component can be activated at or immediately prior to use during filling and sealing of a container, made wholly or partly from the article, with an oxygen sensitive material.

Thus, “trigger” refers to subjecting an article to actinic radiation as described above; “triggered” refers to an article that has been subjected to such actinic radiation; “initiation” refers to the point in time at which oxygen scavenging actually begins or is activated; and “induction time” refers to the length of time, if any, between triggering and initiation.

All compositional percentages used herein are presented on a “by weight” basis, unless designated otherwise.

### SUMMARY OF THE INVENTION

In a first aspect of the present invention, a multilayer film comprises a first outer layer comprising a blend of a polymer, and an antifog agent; an internal layer comprising an oxygen scavenger; and a second outer layer comprising a polymer; wherein the antifog agent comprises a material selected from the group consisting of glycerol fatty acid ester, polyglycerol fatty acid ester, polyethylene glycol fatty acid ester, polyethylene glycol alkyl ether, ethoxylated alkyl phenol, sorbitan ester, ethoxylated sorbitan ester, and alkanol; and wherein the first outer layer comprises more than 3% and less than 8%, by weight of the first outer layer, of antifog agent.

In a second aspect of the present invention, a multilayer film comprises a first layer comprising a blend of a polymer and an antifog agent; a second layer comprising an oxygen scavenger; a third layer comprising a polymeric adhesive; a fourth layer comprising a polyamide; a fifth layer comprising an oxygen barrier; a sixth layer comprising a polyamide; a seventh layer comprising a polymeric adhesive; and an eighth layer comprising a polymer; wherein the antifog agent comprises a material selected from the group consisting of glycerol fatty acid ester, polyglycerol fatty acid ester, polyethylene glycol fatty acid ester, polyethylene glycol alkyl ether, ethoxylated alkyl phenol, sorbitan ester, ethoxylated sorbitan ester, and alkanol; and wherein the first layer comprises more than 3% and less than 8%, by weight of the first layer, of antifog agent.

In a third aspect of the present invention, a laminate comprises a multilayer film comprises a first layer comprising a blend of a polymer and an antifog agent; a second layer comprising an oxygen scavenger; a third layer comprising a polymeric adhesive; a fourth layer comprising a polyamide; a fifth layer comprising an oxygen barrier; a sixth layer comprising a polyamide; a seventh layer comprising a polymeric adhesive; and an eighth layer comprising a polymer; and a second film comprising a polyethylene terephthalate, the second film bonded to the eighth layer of the multilayer film; glycerol fatty acid ester, polyglycerol fatty acid ester, polyethylene glycol fatty acid ester, polyethylene glycol alkyl ether, ethoxylated alkyl phenol, sorbitan ester, ethoxylated sorbitan ester, and alkanol; and wherein the first layer comprises more than 3% and less than 8%, by weight of the first layer, of antifog agent.

In a fourth aspect of the present invention, a laminate comprises a first layer comprising a blend of a polymer, and an antifog agent; a second layer comprising an oxygen scavenger; and a third layer comprising a polymer; and a second film comprising a polyethylene terephthalate, the second film bonded to the third layer of the multilayer film; wherein the antifog agent comprises a material selected from the group consisting of glycerol fatty acid ester, polyglycerol fatty acid ester, polyethylene glycol fatty acid ester, polyethylene glycol alkyl ether, ethoxylated alkyl phenol, sorbitan ester, ethoxylated sorbitan ester, and alkanol; and wherein the first layer comprises more than 3% and less than 8%, by weight of the first layer, of antifog agent.

### DETAILED DESCRIPTION OF THE INVENTION

The oxygen scavenging film may include multiple layers, dependent upon the properties required of the film. For example, layers to achieve appropriate slip, modulus, oxygen or water vapor barrier, oxygen scavenging, meat adhesion, heat seal, or other chemical or physical properties can optionally be included. The film may be manufactured by a variety of processes including, extrusion, coextrusion, lamination, coating, and the like.

An outer layer of the film, preferably a layer that will function as a sealant layer of the film, comprises a blend of one or more polymers with the antifog agent. Polymers that may be used for the surface layer include any resin typically used to formulate packaging films with excellent heat seal properties such as various polyolefin copolymers including ethylene/alpha olefin copolymer, ethylene/vinyl acetate copolymer, ionomer resin, ethylene/acrylic or methacrylic acid copolymer, ethylene/acrylate or methacrylate copolymer, low density polyethylene, or blends of any of these materials.

A variety of antifog agents may be incorporated into the outermost layer of the oxygen scavenging film. Preferred antifog agents include glycerol fatty acid ester, polyglycerol fatty acid ester, polyethylene glycol fatty acid ester, polyethylene glycol alkyl ether, ethoxylated alkyl phenol, sorbitan ester, ethoxylated sorbitan ester, and alkanol, or blends of any of these materials with each other or other antifog materials. Of the antifog agents examined, ethoxylated alkyl phenol, such as ethoxylated nonylphenol, with 4 moles ethylene oxide; and a blend of glycerol fatty acid esters, such as a blend of about 88% mono- and di-glycerides, and about 12% propylene glycol, are preferred. UV transparency is a further beneficial property for oxygen scavenging films, and glycerol fatty acid esters are more UV transparent than ethoxylated alkyl phenols. Additional materials that can be incorporated into an outer layer of the film include antiblock agents, slip agents, etc.

Oxagen Barrier Film

High oxygen barrier films can be made from materials having an oxygen permeability, of the barrier material, less than 500 cm³ O₂/m²·day·atmosphere (tested at 1 mil thick and at 25° C. according to ASTM D3985), preferably less than 100, more preferably less than 50 and most preferably less than 25 cm³ O₂/m²·day·atmosphere such as less than 10, less than 5, and less than 1 cm³ O₂/m²·day·atmosphere. Examples of polymeric materials with low oxygen transmission rates are ethylene/vinyl alcohol copolymer (EVOH), polyvinylidene dichloride (PVDC), vinylidene chloride/methyl acrylate copolymer, polyamide, and polyester.

Alternatively, metal foil or SiOx compounds can be used to provide low oxygen transmission to the container. Metallized foils can include a sputter coating or other application of a metal layer to a polymeric substrate such as high density polyethylene (HDPE), ethylene/vinyl alcohol copolymer (EVOH), polypropylene (PP), polyethylene terephthalate (PET),polyethylene naphthalate (PEN), and polyamide (PA).

Alternatively, oxide coated webs (e.g. aluminum oxide or silicon oxide) can be used to provide low oxygen transmission to the container. Oxide coated foils can include a coating or other application of the oxide, such as alumina or silica, to a polymeric substrate such as high density polyethylene (HDPE), ethylene/vinyl alcohol copolymer (EVOH), polypropylene (PP), polyethylene terephthalate (PET),polyethylene naphthalate (PEN), and polyamide (PA).

Even a sufficiently thick layer of a polyolefin such as LLDPE, or PVC (polyvinyl chloride) can in some instances provide a sufficiently low oxygen transmission rate for the overall film for its intended function. The exact oxygen permeability optimally required for a given application can readily be determined through experimentation by one skilled in the art.

Multilayer films of the invention can be made using conventional extrusion, coextrusion, or lamination processes. Likewise, conventional manufacturing processes can be used to make a pouch, a bag, or other container from the film.

Hermetic sealing of a pouch, bag, or other container made from the film of the invention will typically be preferable.

The exact requirements of a container made from the film will depend on a variety of factors, including the chemical nature of the oxygen scavenger, amount of the oxygen scavenger, concentration of the oxygen scavenger in a host material or diluent, physical configuration of the oxygen scavenger, presence of hermetic sealing, vacuumization and/or modified atmosphere inside the container, initial oxygen concentration inside the container, intended end use of the oxygen scavenger, intended storage time of the container before use, level of initial dose of actinic radiation, etc.

The Oxygen Scavenger

Oxygen scavengers suitable for commercial use in articles of the present invention, such as films, are disclosed in U.S. Pat. No. 5,350,622, and a method of initiating oxygen scavenging generally is disclosed in U.S. Pat. No. 5,211,875. Suitable equipment for initiating oxygen scavenging is disclosed in U.S. Pat. No. 6,287,481 (Luthra et al.). These patents are incorporated herein by reference in their entirety. According to U.S. Pat. No. 5,350,622, oxygen scavengers are made of an ethylenically unsaturated hydrocarbon and transition metal catalyst. The preferred ethylenically unsaturated hydrocarbon may be either substituted or unsubstituted. As defined herein, an unsubstituted ethylenically unsaturated hydrocarbon is any compound that possesses at least one aliphatic carbon-carbon double bond and comprises 100% by weight carbon and hydrogen. A substituted ethylenically unsaturated hydrocarbon is defined herein as an ethylenically unsaturated hydrocarbon which possesses at least one aliphatic carbon-carbon double bond and comprises about 50%-99% by weight carbon and hydrogen. Preferable substituted or unsubstituted ethylenically unsaturated hydrocarbons are those having two or more ethylenically unsaturated groups per molecule. More preferably, it is a polymeric compound having three or more ethylenically unsaturated groups and a molecular weight equal to or greater than 1,000 weight average molecular weight.

Examples of unsubstituted ethylenically unsaturated hydrocarbons include, but are not limited to, diene polymers such as polyisoprene, (e.g., trans-polyisoprene) and copolymers thereof, cis and trans 1,4-polybutadiene, 1,2-polybutadienes, (which are defined as those polybutadienes possessing greater than or equal to 50% 1,2 microstructure), and copolymers thereof, such as styrene/butadiene copolymer and styrene/isoprene copolymer. Such hydrocarbons also include polymeric compounds such as polypentenamer, polyoctenamer, and other polymers prepared by cyclic olefin metathesis; diene oligomers such as squalene; and polymers or copolymers with unsaturation derived from dicyclopentadiene, norbornadiene, 5-ethylidene-2-norbornene, 5-vinyl-2-norbornene, 4-vinylcyclohexene, 1,7-octadiene, or other monomers containing more than one carbon-carbon double bond (conjugated or non-conjugated).

Examples of substituted ethylenically unsaturated hydrocarbons include, but are not limited to, those with oxygen-containing moieties, such as esters, carboxylic acids, aldehydes, ethers, ketones, alcohols, peroxides, and/or hydroperoxides. Specific examples of such hydrocarbons include, but are not limited to, condensation polymers such as polyesters derived from monomers containing carbon-carbon double bonds, and unsaturated fatty acids such as oleic, ricinoleic, dehydrated ricinoleic, and linoleic acids and derivatives thereof, e.g. esters. Such hydrocarbons also include polymers or copolymers derived from (meth)allyl (meth)acrylates. Suitable oxygen scavenging polymers can be made by transesterification. Such polymers are disclosed in U.S. Pat. No. 5,859,145 (Ching et al.) (Chevron Research and Technology Company), incorporated herein by reference as if set forth in full. The composition used may also comprise a mixture of two or more of the substituted or unsubstituted ethylenically unsaturated hydrocarbons described above. While a weight average molecular weight of 1,000 or more is preferred, an ethylenically unsaturated hydrocarbon having a lower molecular weight is usable, especially if it is blended with a film-forming polymer or blend of polymers.

An additional example of oxygen scavengers which can be used in connection with this invention are disclosed in PCT patent publication WO 99/48963 (Chevron Chemical et al.), incorporated herein by reference in its entirety. These oxygen scavengers include a polymer or oligomer having at least one cyclohexene group or functionality. These oxygen scavengers include a polymer having a polymeric backbone, cyclic olefinic pendent group, and linking group linking the olefinic pendent group to the polymeric backbone.

An oxygen scavenging composition suitable for use with the invention comprises:

(a) a polymer or lower molecular weight material containing substituted cyclohexene functionality according to the following diagram:

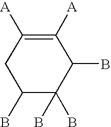

where A may be hydrogen or methyl and either one or two of the B groups is a heteroatom-containing linkage which attaches the cyclohexene ring to the said material, and wherein the remaining B groups are hydrogen or methyl;

(b) a transition metal catalyst; and optionally

(c) a photoinitiator.

The compositions may be polymeric in nature or they may be lower molecular weight materials. In either case they may be blended with further polymers or other additives. In the case of low molecular weight materials they will most likely be compounded with a carrier resin before use.

When used in forming a packaging article, the oxygen scavenging composition of the present invention can include only the above-described polymers and a transition metal catalyst. However, photoinitiators can be added to further facilitate and control the initiation of oxygen scavenging properties. Suitable photoinitiators are known to those skilled in the art. Specific examples include, but are not limited to, benzophenone, and its derivatives, such as methoxybenzophenone, dimethoxybenzophenone, dimethylbenzophenone, diphenoxybenzophenone, allyloxybenzophenone, diallyloxybenzophenone, dodecyloxybenzophenone, dibenzosuberone, 4,4′-bis(4-isopropylphenoxy)benzophenone, 4-morpholinobenzophenone, 4-aminobenzophenone, tribenzoyl triphenylbenzene, tritoluoyl triphenylbenzene, 4,4′-bis(dimethylamino)benzophenone, acetophenone and its derivatives, such as, o-methoxy-acetophenone, 4′-methoxyacetophenone, valerophenone, hexanophenone, α-phenyl-butyrophenone, p-morpholinopropiophenone, benzoin and its derivatives, such as, benzoin methyl ether, benzoin butyl ether, benzoin tetrahydropyranyl ether, 4-o-morpholinodeoxybenzoin, substituted and unsubstituted anthraquinones, α-tetralone, acenaphthenequinone, 9-acetylphenanthrene, 2-acetyl-phenanthrene, 10-thioxanthenone, 3-acetyl-phenanthrene, 3-acetylindole, 9-fluorenone, 1-indanone, 1,3,5-triacetylbenzene, thioxanthen-9-one, isopropylthioxanthen-9-one, xanthene-9-one, 7-H-benz[de]anthracen-7-one, 1′-acetonaphthone, 2′-acetonaphthone, acetonaphthone, 2,4,6-trimethylbenzoyldiphenylphosphine oxide, bis(2,4,6-trimethylbenzoyl)phenylphosphine oxide, ethyl-2,4,6-trimethylbenzoylphenyl phosphinate, bis(2,6-dimethoxybenzoyl)-2,4,4-trimethylpentyl phosphine oxide, benz[a]anthracene-7,12-dione, 2,2-dimethoxy-2-phenylacetophenone, α,α-diethoxyacetophenone, α,α-dibutoxyacetophenone, 4-benzoyl-4′-methyl(diphenyl sulfide) and the like. Single oxygen-generating photosensitizers such as Rose Bengal, methylene blue, and tetraphenylporphine as well as polymeric initiators such as poly(ethylene carbon monoxide) and oligo[2-hydroxy-2-methyl-1-[4-(1-methylvinyl)-phenyl]propanone] also can be used. The amount of photoinitiator can depend on the amount and type of cyclic unsaturation present in the polymer, the wavelength and intensity of radiation used, the nature and amount of antioxidants used, and the type of photoinitiator used.

Also suitable for use in the present invention is the oxygen scavenger of U.S. Pat. No. 6,255,248 (Bansleben et al.), incorporated herein by reference in its entirety, which discloses a copolymer of ethylene and a strained, cyclic alkylene, preferably cyclopentene; and a transition metal catalyst.

Another oxygen scavenger which can be used in connection with this invention is the oxygen scavenger of U.S. Pat. No. 6,214,254 (Gauthier et al.), incorporated herein by reference in its entirety, which discloses ethylene/vinyl aralkyl copolymer and a transition metal catalyst.

As indicated above, the ethylenically unsaturated hydrocarbon is combined with a transition metal catalyst. Suitable metal catalysts are those which can readily interconvert between at least two oxidation states.

Preferably, the catalyst is in the form of a transition metal salt, with the metal selected from the first, second or third transition series of the Periodic Table. Suitable metals include, but are not limited to, manganese II or III, iron II or III, cobalt II or III, nickel II or III, copper I or II, rhodium II, III or IV, and ruthenium II or III. The oxidation state of the metal when introduced is not necessarily that of the active form. The metal is preferably iron, nickel or copper, more preferably manganese and most preferably cobalt. Suitable counterions for the metal include, but are not limited to, chloride, acetate, stearate, palmitate, caprylate, linoleate, tallate, 2-ethylhexanoate, neodecanote, oleate or naphthenate. Particularly preferable salts include cobalt (II) 2-ethylhexanoate, cobalt stearate, and cobalt (II) neodecanoate. The metal salt may also be an ionomer, in which case a polymeric counterion is employed. Such ionomers are well known in the art.

Any of the above-mentioned oxygen scavengers and transition metal catalyst can be further combined with one or more polymeric diluents, such as thermoplastic polymers which are typically used to form film layers in plastic packaging articles. In the manufacture of certain packaging articles well known thermosets can also be used as the polymeric diluent.

Further additives can also be included in the composition to impart properties desired for the particular article being manufactured. Such additives include, but are not necessarily limited to, fillers, pigments, dyestuffs, antioxidants, stabilizers, processing aids, plasticizers, fire retardants,etc.

The mixing of the components listed above is preferably accomplished by melt blending at a temperature in the range of 50° C. to 300° C. However, alternatives such as the use of a solvent followed by evaporation may also be employed.

Oxygen scavenging structures can sometimes generate reaction byproducts, which can affect the taste and smell of the packaged material (i.e. organoleptic properties), or raise food regulatory issues. This problem can be minimized by the use of polymeric functional barriers. Polymeric functional barriers for oxygen scavenging applications are disclosed in WO 96/08371 to Ching et al.(Chevron Chemical Company),WO 94/06626 to Balloni et al., and copending U.S. patent application Ser. Nos. 08/813752 (Blinka et al.) and 09/445645 (Miranda), all of which are incorporated herein by reference as if set forth in full, and include high glass transition temperature (T_{g}) glassy polymers such as polyethylene terephthalate (PET) and nylon 6 that are preferably further oriented; low T_{g} polymers and their blends; a polymer derived from a propylene monomer; a polymer derived from a methyl acrylate monomer; a polymer derived from a butyl acrylate monomer; a polymer derived from a methacrylic acid monomer; polyethylene terephthalate glycol (PETG); amorphous nylon; ionomer; a polymeric blend including a polyterpene; and poly (lactic acid). The functional barriers can be incorporated into one or more layers of a multilayer film or other article that includes an oxygen scavenging layer.

Resin Identification

| Material | Tradename Or | |
|---|---|---|
| Code | Designation | Source(s) |
| AB1 | 10853 ™ | Ampacet |
| AB2 | KAOPOLITE SF | Kaopolite |
| AB3 | POLYBATCH AB-5 ™ | A. Schulman |
| AD1 | PLEXAR PX 114 ™ | Equistar |
| AD2 | Polyurethane adhesive | — |
| AD3 | PLEXAR PX 107A ™ | Equistar |
| AF1 | MERGITAL LM 3 ™ | Cognis |
| AF2 | ATMER 121 ™ | Ciba Geigy |
| AF3 | TRYCOL 6961 ™ | Henkel |
| AF4 | WITCANOL 300K SPECIAL ™ | Crompton |
| AF5 | CRF104 ™ | Goulston, Takemoto Oil |
| | | and Fat Co. Ltd. |
| AF6 | WITCONOL 695 ™ | Crompton |
| AF7 | PATIONIC 907 ™ | American Ingredients Corp. |
| EV1 | ESCORENE LD-318.92 ™ | ExxonMobil |
| EV2 | PE 1375 ™ | Huntsman |
| EV3 | PE 1335 ™ | Huntsman |
| NY1 | ULTRAMID ™ B 35 NATURAL | BASF |
| NY2 | GRIVORY ™ G21 | EMS |
| OB1 | SOARNOL ™ ET | Nippon Gohsei |
| OS1 | OSP500R ™ or DS4713R ™ | Chevron Phillips |
| OSM1 | DS4560M ™ | Chevron Phillips |
| OSM2 | DS4567M ™ | Chevron Phillips |
| PE1 | DOWLEX ™ 2045.04 | Dow |
| PE2 | DOWLEX ™ 2037 | Dow |
| PE3 | ATTANE ™ 4201 | Dow |
| PE4 | ESCORENE ™ LD-200.48 | Exxon |
| PE5 | DOWLEX ™ 2045.03 | Dow |
| PE6 | PE1042CS15 ™ | Huntsman |
| PE7 | AFFINITY PL 1850G ™ | Dow |
| PE8 | EXACT 4151 ™ | Exxon |
| PE9 | EXACT 4150 ™ | Exxon |
| PE10 | PE 1017 ™ | Chevron |
| PE11 | SLX-9103 ™ | Exxon |
| PET1 | HOSTAPHAN 2DEF/2DEFN ™ | Mitsubishi |
| PET2 | TERPHANE 22.00 ™ | Terphane |
| SL1 | FSU 255E ™ | A. Schulman |
| SX1 | MB50-313 ™ | Dow Corning |

AB1 is a masterbatch having about 80% linear low density polyethylene, and about 20% of an antiblocking agent (diatomaceous earth).

AB2 is an anhydrous aluminum silicate that acts as an antiblocking agent.

AB3 is a masterbatch having about 95% low density polyethylene with about 5% silica, that acts as an antiblocking agent, and antioxidant.

AD1 is an anhydride grafted ethylene/vinyl acetate copolymer (EVA), with 8.5% vinyl acetate monomer, and a melt index of 2.0, used as an adhesive or tie layer.

AD2 is a polyurethane adhesive.

AD3 is an anhydride grafted polyolefin in ethylene/vinyl acetate copolymer (EVA), with between 9% and 11% vinyl acetate monomer, and a melt index of 3.2, used as an adhesive or tie layer.

AF1 is a polyethylene glycol alkyl ether antifog agent having 4 moles ethylene oxide and an alkyl chain with between 70 and 75% having a C₁₂ carbon backbone, and between 30 and 25% having a C₁₄ carbon backbone.

AF2 is a glycerol fatty acid ester antifog agent having a blend of glycerol monooleate and glycerol dioleate.

AF3 is an ethoxylated alkyl phenol antifog agent having nonylphenol, with 4 moles ethylene oxide.

AF4 is a glycerol fatty acid ester antifog agent having a blend of about 88% monoand diglycerides, and about 12% propylene glycol.

AF5 is a blend of glycerol and polyglycerol fatty acid ester antifog agents containing about 50% polyglycerol laurate, about 45% glycerol oleate, and about 5% propylene glycol.

AF6 is a glycerol fatty acid ester antifog agent having a blend of mono- and di-glycerides.

AF7 is a glycerol fatty acid ester antifog agent having 96% minimum distilled monoglycerides.

EV1 is ethylene/vinyl acetate copolymer with 9% vinyl acetate monomer, and a melt index of 2.0.

EV2 is ethylene/vinyl acetate copolymer with 3.6% vinyl acetate monomer, and a melt index of 2.0.

EV3 is ethylene/vinyl acetate copolymer with 3.3% vinyl acetate monomer, and a melt index of 2.0.

NY1 is nylon 6 (polycaprolactam).

NY2 is an amorphous copolyamide (6I/6T) derived from hexamethylene diamine, isophthalic acid, and terephthalic acid.

OB1 is an ethylene/vinyl alcohol copolymer with 38 mole percent ethylene.

OS1 is an oxygen scavenger resin, poly(ethylene/methyl acrylate/cyclohexene methyl acrylate).

OSM1 is a masterbatch produced from a carrier resin (ethylene/methyl acrylate) designated SP1205 from Chevron, with 1%, by weight of the masterbatch, of cobalt present in a prill (solid) cobalt oleate from Sheperd Chemical, and 1%, by weight of the masterbatch, of tribenzoyl triphenyl benzene from Chemfirst Fine Chemicals, Inc.

OSM2 is a masterbatch produced from a carrier resin (ethylene/methyl acrylate) from Chevron, with 1%, by weight of the masterbatch, of cobalt present in a liquid cobalt oleate from Sheperd Chemical, and 1%, by weight of the masterbatch, of tribenzoyl triphenyl benzene from Chemfirst Fine Chemicals, Inc.

PE1 is a linear ethylene/1-octene copolymer with a density of 0.920 gm/cc and an octene-1 comonomer content of 6.5%, and a melt flow index of 1.0.

PE2 is a linear ethylene/1-octene copolymer with a density of 0.935 gm/cc and an octene-1 comonomer content of 2.5%, and a melt flow index of 2.5

PE3 is a linear ethylene/1-octene copolymer with a density of between 0.911 and 0.915 grams/cc, a melt flow index of 3.01, and an octene content of 9%.

PE4 is a low density polyethylene resin with a density of 0.915 grams/cc.

PE5 is a linear ethylene/1-octene copolymer with a density of 0.920 gm/cc and an octene-1 comonomer content of 6.5%, and a melt flow index of 1.1.

PE6 is a low density polyethylene resin with a density of 0.922 grams/cc.

PE7 is a single site catalyzed ethylene/1-octene copolymer with a density of 0.902 grams/cc, a melt index of 3.0, and an octene-1 comonomer content of 12%.

PE8 is a single site catalyzed ethylene/1-hexene copolymer with a density of 0.895 grams/cc, and a melt index of 2.2.

PE9 is a single site catalyzed ethylene/1-hexene copolymer with a density of 0.895 grams/cc, and a melt index of 3.43.

PE10 is a low density polyethylene with a density of 0.918 grams/cc.

PE11 is a single site catalyzed ethylene/hexene/butene terpolymer with a density of 0.902 grams/cc, and a melt index of 2.0.

PET1 is a chemically primed polyethylene terephthalate film.

PET2 is a polyethylene terephthalate film coated with vinylidene chloride/vinyl chloride copolymer.

SL1 is a masterbatch having about 70% low density polyethylene with 25% silica and 5% erucamide.

SX1 is a polysiloxane masterbatch in an LLDPE carrier resin with a density of 0.94 grams/cc.

All compositional percentages given herein are by weight, unless indicated otherwise.

### EXAMPLES

Experiments utilizing sealant layers comprising antifog agents in combination with silica antiblock (AB1) and optionally an ultra-high molecular weight (UHMW) siloxane slip additive (SX1) were performed to evaluate the antifog properties of the sealant layer of oxygen scavenging films. Antifog performance of each of the films was determined according to the following method. Each film sample was irradiated with either a Cryovac model 4104V SIS unit or an AndersonNreeland unit to give a dose of 700-800 mJ/cm² of UV C radiation. Tap water (300 mL) was placed in a 600 mL beaker and allowed to equilibrate at room temperature, 75° F. (24° C.). A piece of the film, with the sealant side facing the water, was formed tightly over the beaker and secured with a rubber band. The beaker was then placed in a refrigerated cooler at 35-40° F. (2-5° C.). Triplicate film specimens on beakers were prepared for each film sample. The specimens were then observed after 48 hours and antifog performance was rated. In rating antifog performance, a 1 to 5 scale was used. A rating of 1 is the worst and an opaque layer of small fog droplets less than ⅛″ (3 mm), with minimum light visibility and poor light transmission, is observed. A rating of 2 has opaque to semitransparent fog droplets greater than ⅛″ (3 mm), with poor visibility and light transmission, noted. Large semi-transparent to transparent drops greater than ¼″ (6 mm), with better visibility and a lens effect due to the droplets is observed for a rating of 3. A rating of 4 has randomly scattered large transparent drops and thus a discontinuous film of water. A rating of 5 is the best and a transparent film with no visible water is noted.

To determine the oxygen scavenging rate of the films, two methods were used to prepare and evaluate the films. In both cases, film samples were UV irradiated with either a Cryovac Model 4104V Scavenging Initiation System (SIS) unit or an Anderson/Vreeland unit to give a dose of 700-800 mJ/cm² of UV C. In one method, irradiated films of well-defined area (usually 200 cm²) were then vacuum packaged in barrier pouches (P 640B, Cryovac® division of Sealed Air Corp., OTR=5 cc/m²/day). The pouches were inflated with 300 cc of nitrogen atmosphere at about 1% residual oxygen. In the second method, irradiated film samples were used as lidstock on a Multivac R230 packaging machine, along with bottom web (T6070B, Cryovac® division of Sealed Air Corp.). Gas flushing with the same 1% residual oxygen was also utilized. Samples were then stored at 4-5° C. (refrigerated) for the duration of the test. Portions of the headspace were periodically withdrawn and analyzed for oxygen with a Mocon Pac Check™ model 400 or 450 oxygen analyzer. The average oxygen scavenging rate is calculated by considering only the end points, with the following formula: Average Rate=cc O₂ scavenged/(m²·day), and in these examples was calculated 4 days after UV triggering. The peak (instantaneous) rate is the highest scavenging rate observed during any sampling period, and is given by: Δ cc O₂ scavenged/(m²·Δday), where Δ is the incremental change between two consecutive measurements. Measurements are typically taken on the day of triggering and after 1, 4, 7, 14, and 21 days after triggering. Rates are further reported as the mean of at least three replicates.

Eight layer oxygen scavenging films with an antifog (AF4) containing sealant layer and having oxygen barrier properties were prepared and then laminated with solvent-based adhesive (AD2) to chemically primed PET (PET1). The film structure, as well as the 48 hour antifog performance and refrigerated oxygen scavenging performance after UV triggering, are seen below. For comparison, the film structure of a five layer, non-oxygen scavenging, conventional antifog film containing the same AF4 antifog agent, and its 48 hour antifog performance, are shown as Comparative Example 5.

### Comparative Example 1

| Sealant | OSL | Tie | Nylon | Barrier | Nylon | Tie | Bulk | Adh. | Abuse |
|---|---|---|---|---|---|---|---|---|---|
| 89% PE3 + 7% | 90% OS1 + 10% | AD1 | 80% NY1 + 20% | OB1 | 80% NY1 + 20% | AD1 | PE6 | AD2 | PET1 |
| AB1 + 4% | OSM1 | | NY2 | | NY2 | | | | |
| SX1¹ | | | | | | | | | |
| 0.25 mil | 0.75 mil | 0.2 mil | 0.2 mil | 0.25 mil | 0.2 mil | 0.2 mil | 0.5 mil | 0.05 mil | 0.5 mil |

¹The percentages shown in the examples reflect the commercial resins used. The additives shown in the sealant
layer of Example 1 include an active component in a masterbatch. The antiblock agent AB1 is 10853 from Ampacet.
This composition contains about 20%, by weight of the commercial material, of silica in the form of a diatomaceous
earth, blended in a host polymer, linear low density polyethylene. Therefore, although the AB1 forms
about 7% of the sealant layer, the active antiblock material (silica) within AB1 forms about 1.4% of the composition
of the sealant layer. Likewise, the slip agent SX1 is MB50-313 from Dow Corning. This composition contains
approximately 50%, by weight of the commercial material, of siloxane. Thus, although the SX1 forms about 4%
of the sealant layer, the active slip material (siloxane) within SX1 forms about 2% of the composition of the sealant
layer. The same holds true for AB1 and SX1 appearing elsewhere in the examples.

| 48 Hour UV Triggered | Refrigerated OS Rate (cc/m²/day) |
|---|---|
| Antifog | Average and Peak Values |
| 2.0 | 31.8 and 58.2 |

### Example 2

| | | | | | | | | | |
|---|---|---|---|---|---|---|---|---|---|
| 87% PE3 + 7% | 90% OS1 + 10% | AD1 | 80% NY1 + 20% | OB1 | 80% NY1 + 20% | AD1 | PE6 | AD2 | PET1 |
| AB1 + 2% | OSM1 | | NY2 | | NY2 | | | | |
| SX1 + 4% | | | | | | | | | |
| AF4 | | | | | | | | | |
| 0.25 mil | 0.75 mil | 0.2 mil | 0.2 mil | 0.25 mil | 0.2 mil | 0.2 mil | 0.5 mil | 0.05 mil | 0.5 mil |

| 48 Hour UV Triggered | Refrigerated OS Rate (cc/m²/day) |
|---|---|
| Antifog | Average and Peak Values |
| 5.0 | 34.7 and 60.7 |

### Example 3

| | | | | | | | | | |
|---|---|---|---|---|---|---|---|---|---|
| 85% PE3 + 7% | 90% OS1 + 10% | AD1 | 80% NY1 + 20% | OB1 | 80% NY1 + 20% | AD1 | PE6 | AD2 | PET1 |
| AB1 + 2% | OSM1 | | NY2 | | NY2 | | | | |
| SX1 + 6% | | | | | | | | | |
| AF4 | | | | | | | | | |
| 0.25 mil | 0.75 mil | 0.2 mil | 0.2 mil | 0.25 mil | 0.2 mil | 0.2 mil | 0.5 mil | 0.05 mil | 0.5 mil |

| 48 Hour UV Triggered | Refrigerated OS Rate (cc/m²/day) |
|---|---|
| Antifog | Average and Peak Values |
| 5.0 | 39.2 and 72.0 |

### Example 4

| | | | | | | | | | |
|---|---|---|---|---|---|---|---|---|---|
| 85% PE7 + 8% | 90% OS1 + 10% | AD3 | 80% NY1 + 20% | OB1 | 80% NY1 + 20% | AD3 | PE6 | AD2 | PET1 |
| AB1 + 3% | OSM1 | | NY2 | | NY2 | | | | |
| SX1 + 4% | | | | | | | | | |
| AF4 | | | | | | | | | |
| 0.25 mil | 0.75 mil | 0.2 mil | 0.2 mil | 0.25 mil | 0.2 mil | 0.2 mil | 0.5 mil | 0.05 mil | 0.5 mil |

| 48 Hour UV Triggered | Refrigerated OS Rate (cc/m²/day) |
|---|---|
| Antifog | Average and Peak Values |
| 5.0 | 39.9 and 91.8 |

### Comparative Example 5

(commercial antifog film)

| Sealant | Substrate | Core | Substrate | Sealant |
|---|---|---|---|---|
| 47% PE1 + | PE1 | EV3 | PE1 | 47% PE1 + |
| 23.5% EV3 + | | | | 23.5% EV3 + |
| 23.5% PE2 + | | | | 23.5% PE2 + |
| 2% AB2 + | | | | 2% AB2 + |
| 4% AF4 | | | | 4% AF4 |
| 0.1 mil | 0.15 mil | 0.1 mil | 0.15 mil | 0.1 mil |

48 Hour Antifog
3.3

Examples 2, 3 and 4 indicate that excellent antifog and oxygen scavenging characteristics can be achieved with laminated eight layer oxygen scavenging antifog films. Comparison of Examples 2, 4, and 5 indicates that the oxygen scavenging antifog films (Examples 2 and 4) have superior antifog performance, compared to a commercial antifog film (Comparative Example 5) with the same AF4 antifog agent at the same loading, but in both outer sealant layers. As seen by Examples 1 to 4, the presence of the antifog agent AF4 in the oxygen scavenging film is observed to enhance both the antifog performance and the oxygen scavenging rate. Evaluation of laminated oxygen scavenging antifog films as lidstock on HFFS packaging equipment indicated no significant degradation of the heat seal properties of the forming web, nor any significant interlayer delamination issues with the film itself.

Three layer oxygen scavenging antifog films that were laminated with solvent based adhesive (AD2) to PVdC coated PET (PET2) to form a high barrier oxygen scavenging antifog film were also examined. The film structure, as well as the antifog performance and refrigerated oxygen scavenging performance 48 hours after each film was UV triggered, are seen below.

### Comparative Example 6

| Sealant | OSL | Bulk | Adh. | Barrier/Abuse |
|---|---|---|---|---|
| 93% PE3 + | 90% OS1 + | PE5 | AD2 | PET2 |
| 7% AB1¹ | 10% OSM2 | | | |
| 0.25 mil | 0.75 mil | 1.5 mil | 0.05 mil | 0.5 mil |

| 48 Hour UV Triggered | Refrigerated OS Rate (cc/m²/day) |
|---|---|
| Antifog | Average and Peak Values |
| 2.0 | 31.2 and 47.4 |

### Example 7

| | | | | |
|---|---|---|---|---|
| 89% PE3 + | 90% OS1 + | PE5 | AD2 | PET2 |
| 7% AB¹ + 4% AF3 | 10% OSM1 | | | |
| 0.25 mil | 0.75 mil | 1.5 mil | 0.05 mil | 0.5 mil |

| 48 Hour UV Triggered | Refrigerated OS Rate (cc/m²/day) |
|---|---|
| Antifog | Average and Peak Values |
| 3.3 | 33.5 and 68.7 |

### Example 8

| | | | | |
|---|---|---|---|---|
| 87% PE3 + | 90% OS1 + | PE5 | AD2 | PET2 |
| 7% AB¹ + 6% AF3 | 10% OSM1 | | | |
| 0.25 mil | 0.75 mil | 1.5 mil | 0.05 mil | 0.5 mil |

| 48 Hour UV Triggered | Refrigerated OS Rate (cc/m²/day) |
|---|---|
| Antifog | Average and Peak Values |
| 3.2 | 33.6 and 77.4 |

### Example 9

| | | | | |
|---|---|---|---|---|
| 58% PE3 + | 90% OS1 + | PE5 | AD2 | PET2 |
| 31% PE4 + | 10% OSM1 | | | |
| 7% AB¹ + | | | | |
| 4% AF3 | | | | |
| 0.25 mil | 0.75 mil | 1.5 mil | 0.05 mil | 0.5 mil |

| 48 Hour UV Triggered | Refrigerated OS Rate (cc/m²/day) |
|---|---|
| Antifog | Average and Peak Values |
| 4.4 | 35.1 and 60.3 |

### Example 10

| | | | | |
|---|---|---|---|---|
| 87% PE3 + | 90% OS1 + | PE5 | AD2 | PET2 |
| 7% AB¹ + | 10% OSM1 | | | |
| 6% AF4 | | | | |
| 0.25 mil | 0.75 mil | 1.5 mil | 0.05 mil | 0.5 mil |

| 48 Hour UV Triggered | Refrigerated OS Rate (cc/m²/day) |
|---|---|
| Antifog | Average and Peak Values |
| 4.1 | 30.2 and 56.6 |

Examples 7-10 above indicate that improved antifog and oxygen scavenging characteristics were achieved with laminated 3 layer films containing either AF4 or AF3 antifog agents, compared with Comparative Example 6 containing no antifog agent. In all agents, compared with Comparative Example 6 containing no antifog agent. In all cases, the presence of the antifog agent enhanced the film's oxygen scavenging rate in addition to providing antifog properties. Evaluation of laminated oxygen scavenging antifog films as lidstock on HFFS packaging equipment indicated no significant degradation of the heat seal properties of the forming web, nor any significant interlayer delamination issues with the film itself.

Examination of non-laminated three layer oxygen scavenging films, without a barrier layer, was also performed. In comparison, sealant layers utilizing erucamide, a conventional slip agent, either in the sealant layer alone or also in the bulk layer, to yield high-slip films are also shown for comparison. The film structure, as well as the 48 hour antifog performance, refrigerated oxygen scavenging performance, and heat seal bond strength after each film was UV triggered, and for comparative examples the kinetic coefficient of friction (COF), are seen below.

### Comparative Example 11

| Sealant | OSL | Bulk layer |
|---|---|---|
| 62% PE8 + | 90% OS1 + | 95% EV2 + |
| 30% PE4 + | 10% OSM1 | 5% AB1¹ |
| 8% AB1¹ | | |
| 0.25 mil | 0.75 mil | 1.0 mil |

| 48 Hour UV Triggered | Refrigerated OS Rate (cc/m²/day) |
|---|---|
| Antifog | Average and Peak Values |
| 1.5 | 28.3 and 50.1 |

### Example 12

| | | |
|---|---|---|
| 60% PE8 + | 90% OS1 + | 95% EV2 + |
| 28% PE4 + | 10% OSM1 | 5% AB1¹ |
| 8% AB1¹ + | | |
| 4% AF3 | | |
| 0.25 mil | 0.75 mil | 1.0 mil |

| 48 Hour UV Triggered | Refrigerated OS Rate (cc/m²/day) |
|---|---|
| Antifog | Average and Peak Values |
| 3.8 | 28.6 and 51.9 |

### Example 13

| | | |
|---|---|---|
| 57% PE8 + | 90% OS1 + | 95% EV2 + |
| 29% PE4 + | 10% OSM1 | 5% AB1¹ |
| 8% AB1¹ + | | |
| 6% AF3 | | |
| 0.25 mil | 0.75 mil | 1.0 mil |

| 48 Hour UV Triggered | Refrigerated OS Rate (cc/m²/day) |
|---|---|
| Antifog | Average and Peak Values |
| 3.9 | 29.7 and 56.7 |

### Comparative Example 14

| | | |
|---|---|---|
| 56% PE8 + 28% | 90% OS1 + 10% | 95% EV2 + 5% |
| PE4 + 8% | OSM1 | AB1 |
| AB1 + 8% | | |
| AF3 | | |
| 0.25 mil | 0.75 mil | 1.0 mil |

| 48 Hour UV Triggered | Refrigerated OS Rate (cc/m²/day) |
|---|---|
| Antifog | Average and Peak Values |
| 3.1 | 23.5 and 50.4 |

### Comparative Example 15

| | | |
|---|---|---|
| 92% EV1 + 8% | 90% OS1 + | 95% EV2 + 5% |
| AB1¹ | 10% OSM2 | AB1¹ |
| 0.25 mil | 0.75 mil | 1.0 mil |

| | | Heat Seal |
|---|---|---|
| | | Bond |
| 48 Hour UV Triggered | Refrigerated OS Rate (cc/m²/day) | Strength |
| Antifog | Average and Peak Values | (lb/in) |
| 1.6 | 27.4 and 38.1 | 3.6 ± 1.0 |

### Example 16

| | | |
|---|---|---|
| 88% EV1 + 8% | 90% OS1 + 10% | 95% EV2 + 5% |
| AB1¹ + 4% | OSM2 | 5% AB1¹ |
| AF3 | | |
| 0.25 mil | 0.75 mil | 1.0 mil |

| | | Heat Seal |
|---|---|---|
| | | Bond |
| 48 Hour UV Triggered | Refrigerated OS Rate (cc/m²/day) | Strength |
| Antifog | Average and Peak Values | (lb/in) |
| 4.9 | 27.1 and 51.0 | 3.5 ± 0.7 |

### Example 17

| | | |
|---|---|---|
| 86% EV1 + 8% | 90% OS1 + 10% | 95% EV2 + 5% |
| AB1 + 4% | OSM2 | AB1 |
| AF1 + 2% | | |
| AF2 | | |
| 0.25 mil | 0.75 mil | 1.0 mil |

48 Hour UV Triggered
Antifog
4.7

### Comparative Example 18

| | | |
|---|---|---|
| 62% PE9 + 30% | 90% OS1 + 10% | 95% EV2 + 5% |
| PE10 + 8% | OSM2 | AB1 |
| AB1 | | |
| 0.25 mil | 0.75 mil | 1.0 mil |

| 48 Hour UV Triggered | Refrigerated OS Rate (cc/m²/day) |
|---|---|
| Antifog | Average and Peak Values |
| 2.0 | 30.4 and 60.4 |

### Comparative Example 19

| | | |
|---|---|---|
| 60% PE9 + 29% | 90% OS1 + 10% | 95% EV2 + 5% |
| PE10 + 8% | OSM2 | AB1 |
| AB1 + 2% | | |
| AF1 + 1% | | |
| AF2 | | |
| 0.25 mil | 0.75 mil | 1.0 mil |

| 48 Hour UV Triggered | Refrigerated OS Rate (cc/m²/day) |
|---|---|
| Antifog | Average and Peak Values |
| 2.0 | 28.9 and 47.3 |

### Example 20

| | | |
|---|---|---|
| 60% PE9 + 26% | 90% OS1 + 10% | 95% EV2 + 5% |
| PE10 + 8% | OSM2 | AB1 |
| AB1 + 4% | | |
| AF1 + 2% | | |
| AF2 | | |
| 0.25 mil | 0.75 mil | 1.0 mil |

| 48 Hour UV Triggered | Refrigerated OS Rate (cc/m²/day) |
|---|---|
| Antifog | Average and Peak Values |
| 4.8 | 31.0 and 48.2 |

### Comparative Example 21

| | | |
|---|---|---|
| PE11 | 90% OS1 + 10% | 92% PE5 + 8% |
| | OSM2 | AB3² |
| 0.25 mil | 0.5 mil | 0.8 mil |

| 48 Hour UV Triggered | Refrigerated OS Rate (cc/m²/day) |
|---|---|
| Antifog | Average and Peak Values |
| | 27.1 and 28.5 |

²The antiblock agent AB3 is POLYBATCH AB-5 ™ from A. Schulman. AB3 is a masterbatch having about 95% low density polyethylene with about 5% silica and antioxidant. Thus, although the AB3 forms about 8% of the relevant layer, the active antiblock material (silica) within AB3 forms about 0.4% of the composition of the layer.

### Example 22

| | | |
|---|---|---|
| 93% PE11 + 2% | 90% OS1 + 10% | 95% EV2 + 5% |
| AB2 + 3.4% | OSM1 | AB1 |
| AF5 + 0.8% | | |
| AF6 + 0.8% | | |
| AF7 | | |
| 0.25 mil | 0.75 mil | 1.0 mil |

| 48 Hour UV Triggered | Refrigerated OS Rate (cc/m²/day) |
|---|---|
| Antifog | Average and Peak Values |
| 4.0 | 21.9 and 26.0 |

### Comparative Example 23

| | | |
|---|---|---|
| PE3 | 90% OS1 + 10% | 92% PE5 + 8% |
| | OSM2 | AB3 |
| 0.25 mil | 0.5 mil | 0.8 mil |

| | Refrigerated OS Rate (cc/m²/day) |
|---|---|
| COF: | Average and Peak Values |
| block | 30.3 and 53.9 |

### Comparative Example 24

| | | |
|---|---|---|
| 90% PE3 + 10% | 90% OS1 + 10% | 92% PE5 + 8% |
| SL1³ | OSM2 | AB3 |
| 0.25 mil | 0.5 mil | 0.8 mil |

³The slip agent SL1 is FSU 255E ™ from A. Schulman. SL1 is a
masterbatch having about 70% low density polyethylene with about
25% silica and about 5% erucamide. Thus, although the
SL1 forms about 10% of the relevant layer, the active
slip materials (silica and erucamide) within SL1 form
about 2.5% and 0.5% respectively of the composition of
the layer.

| | Refrigerated OS Rate (cc/m²/day) |
|---|---|
| COF: | Average and Peak Values |
| 0.61 | 24.5 and 39.3 |

### Comparative Example 25

| | | |
|---|---|---|
| 90% PE3 + 10% | 90% OS1 + 10% | 92% PE5 + 8% |
| SL2³ | OSM2 | SL2³ |
| 0.25 mil | 0.5 mil | 1.5 mil |

| | Refrigerated OS Rate (cc/m²/day) |
|---|---|
| COF: | Average and Peak Values |
| 0.22 | 18.9 and 26.6 |

As can be seen from Examples 11 to 22, the use of several antifog agents (AF1-3 and AF5-7) at levels between 3 and 8 wt % provided improved antifog performance, without significantly degrading heat seal (compare Examples 15 and 16) or oxygen scavenging performance. As with Examples 1-3 and 6-8, increasing levels of antifog agent unexpectedly improved oxygen scavenging performance, but there is an upper limit to antifog level (see Examples 11 to 14). In comparison, use of another migratory film additive, erucamide slip agent, at levels as low as approximately 10 times less than the amount of antifog agent, are seen to significantly reduce oxygen scavenging rates (see Comparative Examples 24 and 25). Thus, the ability of the antifog agent to improve antifog performance and not degrade or actually enhance oxygen scavenging rate is an unexpected finding of the present invention.

In a preferred embodiment of the invention, the first outer layer of the film comprises more than 3% and less than 8% antifog agent, by weight of the first outer layer. More preferably, the first outer layer of the film comprises between 4% and 6% antifog agent, by weight of the first outer layer. The second outer layer preferably comprises less than 3% antifog agent, by weight of the second outer layer; more preferably less than 1% antifog agent by weight of the second outer layer, and most preferably the second outer layer does not have any extruded antifog agent.

Evaluation of the organoleptic properties of several oxygen scavenging antifog films was performed in comparison to a non-antifog control oxygen scavenging film. Samples were prepared by the following method. Packages containing 200 ml of water were formed on a Multivac R230 packaging machine equipped with a Cryovac Model 4104V Scavenging Initiation System (SIS) using antifog and non-antifog oxygen scavenging films as the top web and Cryovac T6070B as the bottom web. For the non-laminated, three-layer oxygen scavenging antifog films, samples of the antifog film were taped to Cryovac R660B laminate barrier film to form the barrier top web. Packages were flushed with approximately 2% residual oxygen in nitrogen and had an approximate headspace of 800 cc. Two packages of each film were prepared for replicate purposes. Packages were evaluated for oxygen scavenging performance and then stored at room temperature, 75° F. (24° C.), for 7 days.

Sensory analysis with a panel trained for oxygen scavenging films was performed to determine if the antifog film imparted a different taste to water packaged with the oxygen scavenging films. For the Triangle difference organoleptic test method, three water samples were presented to the panelists, where two of the water samples were identical and the panelists were asked to identify the odd water sample and comment on taste differences. Statistical difference at the 0.05 probability or a level was utilized to assess whether there was a significant organoleptic difference between the antifog and non-antifog oxygen scavenging films. Based on this criteria, no significant difference was noted, suggesting that several different categories of antifog agents (AF1-3) do not significantly alter the organoleptic properties of the oxygen scavenging film.

Polymeric adhesives that can be used in embodiments of the present invention include e.g. ethylene/vinyl acetate copolymer; anhydride grafted ethylene/vinyl acetate copolymer; anhydride grafted ethylene/alpha olefin copolymer; and anhydride grafted low density polyethylene.

The invention is not limited to the illustrations described herein, which are deemed to be merely illustrative, and susceptible of modification of form, size, arrangement of parts and details of operation.

What is claimed is:

1. A multilayer film comprising:
a) a first outer layer comprising a blend of
i) a polymer, and
ii) an antifog agent;
b) an internal layer comprising an oxygen scavenger; and
c) a second outer layer comprising a polymer;
wherein the antifog agent comprises a material selected from the group consisting of:
i) glycerol fatty acid ester,
ii) polyglycerol fatty acid ester,
iii) polyethylene glycol fatty acid ester,
iv) polyethylene glycol alkyl ether,
v) ethoxylated alkyl phenol,
vi) sorbitan ester,
vii) ethoxylated sorbitan ester, and
viii) alkanol; and
wherein the first outer layer comprises more than 3% and less than 8%, by weight of the first outer layer, of antifog agent.

2. The multilayer film of claim 1 wherein the polymer of the first and second outer layers comprises a material selected from the group consisting of:
a) ethylene/alpha olefin copolymer;
b) ethylene/vinyl acetate copolymer;
c) ionomer resin;
d) ethylene/acrylic or methacrylic acid copolymer;
e) ethylene/acrylate or methacrylate copolymer; and
f) low density polyethylene.

3. The multilayer film of claim 1 wherein the oxygen scavenger comprises a material selected from the group consisting of:
i) oxidizable organic compound and a transition metal catalyst,
ii) ethylenically unsaturated hydrocarbon and a transition metal catalyst,
iii) a polymer having a polymeric backbone, cyclic olefinic pendent group, and linking group linking the olefinic pendent group to the polymeric backbone,
iv) a copolymer of ethylene and a strained, cyclic alkylene,
v) ethylene/vinyl aralkyl copolymer,
vi) ascorbate,
vii) isoascorbate,
viii) sulfite,
ix) ascorbate and a transition metal catalyst, the catalyst comprising a simple metal or salt, or a compound, complex or chelate of the transition metal,
x) a transition metal complex or chelate of a polycarboxylic acid, salicylic acid, or polyamine,
xi) a tannin, and
xii) reduced metal.

4. The film of claim 1 comprising an oxygen barrier layer, disposed between the internal layer comprising the oxygen scavenger, and one of the first and second outer layers, the oxygen barrier layer having an oxygen transmission rate of no more than 100 cc/m²/24 hr at 25° C., 0% RH, 1 atm (ASTM D 3985).

5. The film of claim 4 wherein the oxygen barrier comprises a material selected from the group consisting of:
i) polyester,
ii) polyvinyl alcohol,
iii) ethylene vinyl alcohol copolymer,
iv) polyethylene naphthalate,
v) polyamide,
vi) polyamide,
vii) copolyamide,
viii) polyacrylonitrile,
ix) acrylonitrile copolymer,
x) liquid crystal polymer,
xi) SiOₓ,
xii) polyvinyl chloride,
xiii) polyvinylidene chloride,
xiv) vinylidene chloride copolymer,
xv) carbon,
xvi) metal, and
xvii) metal oxide.

6. The film of claim 1 wherein the average oxygen scavenging rate of the film is at least 25 cc/m2/day for at least two days after the oxygen scavenging property of the film is activated.

7. The film of claim 1 wherein the film is cross-linked.

8. The film of claim 1 wherein the film is biaxially oriented and heat shrinkable.

9. A multilayer film comprising:
a) a first layer comprising a blend of:
i) a polymer, and
ii) an antifog agent;
b) a second layer comprising an oxygen scavenger;
c) a third layer comprising a polymeric adhesive;
d) a fourth layer comprising a polyamide;
e) a fifth layer comprising an oxygen barrier;
f) a sixth layer comprising a polyamide;
g) a seventh layer comprising a polymeric adhesive; and
h) an eighth layer comprising a polymer;
wherein the antifog agent comprises a material selected from the group consisting of:
i) glycerol fatty acid ester,
ii) polyglycerol fatty acid ester,
iii) polyethylene glycol fatty acid ester,
iv) polyethylene glycol alkyl ether,
v) ethoxylated alkyl phenol,
vi) sorbitan ester,
vii) ethoxylated sorbitan ester, and
viii) alkanol; and
wherein the first layer comprises more than 3% and less than 8%, by weight of the first layer, of antifog agent.

10. The multilayer film of claim 9 wherein the polymer of the first and eighth layers comprises a material selected from the group consisting of:
a) ethylene/alpha olefin copolymer;
b) ethylene/vinyl acetate copolymer;
c) ionomer resin;
d) ethylene/acrylic or methacrylic acid copolymer;
e) ethylene/acrylate or methacrylate copolymer; and
f) low density polyethylene.

11. The multilayer film of claim 9 wherein the oxygen scavenger of the second layer comprises a material selected from the group consisting of:
i) oxidizable organic compound and a transition metal catalyst,
ii) ethylenically unsaturated hydrocarbon and a transition metal catalyst,
iii) a polymer having a polymeric backbone, cyclic olefinic pendent group, and linking group linking the olefinic pendent group to the polymeric backbone,
iv) a copolymer of ethylene and a strained, cyclic alkylene,
v) ethylene/vinyl aralkyl copolymer,
vi) ascorbate,
vii) isoascorbate,
viii) sulfite,
ix) ascorbate and a transition metal catalyst, the catalyst comprising a simple metal or salt, or a compound, complex or chelate of the transition metal,
x) a transition metal complex or chelate of a polycarboxylic acid, salicylic acid, or polyamine,
xi) a tannin, and
xii) reduced metal.

12. The multilayer film of claim 9 wherein the polymeric adhesive of the third and seventh layers comprises a material selected from the group consisting of:
i) ethylene/vinyl acetate copolymer;
ii) anhydride grafted ethylene/vinyl acetate copolymer;
iii) anhydride grafted ethylene/alpha olefin copolymer; and
iv) anhydride grafted low density polyethylene.

13. The multilayer film of claim 9 wherein the polyamide of the fourth and sixth layers comprises a material selected from the group consisting of:
i) polyamide 6,
ii) polyamide 9,
iii) polyamide 10,
iv) polyamide 11,
v) polyamide 12,
vi) polyamide 66,
vii) polyamide 610,
viii) polyamide 612,
ix) polyamide 6I,
x) polyamide 6T,
xi) polyamide 69,
xii) polyamide 6I/6T,
xiii) polyamide 6/66,
xiv) polyamide 66/6,
xv) polyamide 6/610,
xvi) polyamide 6/69,
xvii) polyamide MXD6,
xviii) polyamide MXD6/MXDI, and
xix) polyamide MXD6/6T.

14. The multilayer film of claim 9 wherein the oxygen barrier of the fifth layer comprises a material selected from the group consisting of:
i) polyester,
ii) polyvinyl alcohol,
iii) ethylene vinyl alcohol copolymer,
iv) polyethylene naphthalate,
v) polyamide,
vi) polyamide,
vii) copolyamide,
viii) polyacrylonitrile,
ix) acrylonitrile copolymer,
x) liquid crystal polymer,
xi) SiOₓ,
xii) polyvinyl chloride,
xiii) polyvinylidene chloride,
xiv) vinylidene chloride copolymer,
xv) carbon,
xvi) metal, and
xvii) metal oxide.

15. The multilayer film of claim 9 wherein the antifog agent comprises a material selected from the group consisting of:
i) glycerol fatty acid ester,
ii) polyglycerol fatty acid ester,
iii) polyethylene glycol fatty acid ester,
iv) polyethylene glycol alkyl ether,
v) ethoxylated alkyl phenol,
vi) sorbitan ester,
vii) ethoxylated sorbitan ester, and
viii) alkanol.

16. A laminate comprising:
a) a multilayer film comprising:
i) a first layer comprising a blend of:
(a) a polymer, and
(b) an antifog agent;
ii) a second layer comprising an oxygen scavenger;
iii) a third layer comprising a polymeric adhesive;
(iv) a fourth layer comprising a polyamide;
(v) a fifth layer comprising an oxygen barrier;
(vi) a sixth layer comprising a polyamide;
(vii) a seventh layer comprising a polymeric adhesive; and
(viii) an eighth layer comprising a polymer, and
b) a second film comprising a polyethylene terephthalate, the second film bonded to the eighth layer of the multilayer film;
wherein the antifog agent comprises a material selected from the group consisting of:
i) glycerol fatty acid ester,
ii) polyglycerol fatty acid ester,
iii) polyethylene glycol fatty acid ester,
iv) polyethylene glycol alkyl ether,
v) ethoxylated alkyl phenol,
vi) sorbitan ester,
vii) ethoxylated sorbitan ester, and
viii) alkanol; and
wherein the first layer comprises more than 3% and less than 8%, by weight of the first layer, of antifog agent.

17. The laminate of claim 16 wherein the antifog agent comprises a material selected from the group consisting of:
i) glycerol fatty acid ester,
ii) polyglycerol fatty acid ester,
iii) polyethylene glycol fatty acid ester,
iv) polyethylene glycol alkyl ether,
v) ethoxylated alkyl phenols,
vi) sorbitan ester,
vii) ethoxylated sorbitan ester, and
viii) alkanol.

18. A laminate comprising:
a) a multilayer film comprising:
i) a first layer comprising a blend of:
(a) a polymer, and
(b) an antifog agent;
ii) a second layer comprising an oxygen scavenger; and
iii) a third layer comprising a polymer, and
b) a second film comprising a polyethylene terephthalate, the second film bonded to the third layer of the multilayer film;
wherein the antifog agent comprises a material selected from the group consisting of:
i) glycerol fatty acid ester,
ii) polyglycerol fatty acid ester,
iii) polyethylene glycol fatty acid ester,
iv) polyethylene glycol alkyl ether,
v) ethoxylated alkyl phenol,
vi) sorbitan ester,
vii) ethoxylated sorbitan ester, and
viii) alkanol; and
wherein the first layer comprises more than 3% and less than 8%, by weight of the first layer, of antifog agent.

19. The laminate of claim 18 wherein the antifog agent comprises a material selected from the group consisting of:
i) glycerol fatty acid ester,
ii) polyglycerol fatty acid ester,
iii) polyethylene glycol fatty acid ester,
iv) polyethylene glycol alkyl ether,
v) ethoxylated alkyl phenols,
vi) sorbitan ester,
vii) ethoxylated sorbitan ester, and
viii) alkanol.

20. The laminate of claim 18 wherein the antifog agent comprises more than 3% and less than 8% by weight of the first layer.
